(19) United States
(12) Patent Application Publication
(10) Pub. No.: US 2014/0165574 A1
(43) Pub. Date: Jun. 19, 2014

(54) EXHAUST PLUG FOR AN AIRCRAFT TURBOJET ENGINE

(71) Applicant: AIRCELLE, Gonfreville L'Orcher (FR)

(72) Inventors: Philippe BIENVENU, Rogerville (FR); Helene Malot, Sainte Adresse (FR)

(73) Assignee: AIRCELLE, Gonfreville L'Orcher (FR)

(21) Appl. No.: 14/177,503

(22) Filed: Feb. 11, 2014

Related U.S. Application Data
(63) Continuation of application No. PCT/FR2012/051574, filed on Jul. 5, 2012.

(51) Int. Cl. F02K 1/04

(52) U.S. Cl. CPC F02K 1/04
USPC 60/770

(57) ABSTRACT

An exhaust plug for an aircraft turbojet engine is provided. The exhaust plug includes a front part being attached to a rear part, and the front and rear parts each have an outer skin. In particular, the front part and the rear part are connected by a connecting flange which is shared by the front and rear parts. The outer skins of the front and rear parts are placed side by side on the connecting flange.

### CROSS-REFERENCE TO RELATED APPLICATIONS

This application is a continuation of International Application No. PCT/FR2012/051574, filed on Jul. 5, 2012, which claims the benefit of FR 11/57322, filed on Aug. 12, 2011. The disclosures of the above applications are incorporated herein by reference.

### FIELD

The present disclosure relates to an exhaust plug for an aircraft turbojet engine.

### BACKGROUND

The statements in this section merely provide background information related to the present disclosure and may not constitute prior art.

As is known in itself, it is generally suitable to provide an exhaust plug/primary nozzle assembly at the rear of an aircraft turbojet engine, so as to optimize the flow of the hot gasses expelled by the turbojet engine on the one hand, and to absorb at least some of the noise created by the interaction of those hot gasses with the ambient air and with the cold air flow expelled by the fan of the turbojet engine on the other hand.

These elements are commonly referred to as a “plug” and a “nozzle” or “primary nozzle”.

Such a traditional exhaust plug 1 is shown in FIG. 1 appended hereto, on which the front and rear of the structure along an engine axis are situated on the left and right sides of the figure, respectively.

This exhaust plug is intended to be positioned downstream from the turbine of the turbojet engine, above which the primary nozzle is placed concentrically. The exhaust plug and the primary nozzle are both fastened on a casing of the turbojet engine by a flange fastening system.

More specifically, the exhaust plug 1 comprises, strictly speaking, a front part 5 (commonly called the “front plug”), which is substantially cylindrical, and a rear part 7 (commonly called the “rear plug”), which is conical.

The front part 5 can in particular be acoustic or stiffened monolithic.

If the first part 5 is acoustic, that means that it comprises at least one peripheral sound attenuation structure of the sandwich type comprising at least one resonator, in particular of the honeycomb type, covered by a perforated outer skin and a solid inner skin.

The outer skin also constitutes an outer surface (sheet) of the front part 5 of the exhaust plug.

If the front part 5 is stiffened monolithic, that means that the structure is made up of a single sheet reinforced by stiffeners.

The rear part 7 is monolithic and stiffened by stiffeners 9d.

The front part 5 and the rear part 7 of the exhaust plug may in particular be made from sheets of metal alloy of the Inconel 625 type and may be assembled using a flange junction system denoted 9b for the front flange part and 9c for the rear flange part.

The front part 5 further comprises an upstream connecting flange 9a designed to allow it to be attached to the rear of the turbojet engine.

FIG. 2 shows that, traditionally, the flange 9b of the front part 5 has a part 11 with a diameter substantially equal to that of the outer skin of said front part 5 on the one hand, and a part 13 with a diameter smaller than that of the flange 9c of the rear part 7 to which it is designed to be connected, such that said part 13 of the flange 9b can be inserted inside the flange 9c of the rear part 7, on the other hand.

Housings 15 formed in the thickness of the flange 9c make it possible to receive bolts 17 passing through said flange 9c and the flange 9b, fastened using nuts 18 attached through the inside of the exhaust plug 1 thus assembled.

The housings 15 make it possible to prevent the heads 19 of the bolts 17 from protruding toward the outside of the plug 1, and thus do not cause aerodynamic losses.

As can be understood in light of the preceding, an exhaust plug of the prior art (FIG. 2) is a complex structure, involving many parts, and has a high manufacturing cost and affects the mass of the assembly, which is not desirable.

### SUMMARY

The present disclosure is provided to simplify the assembly of the front part and rear part of the exhaust plug so as to reduce both the mass and the manufacturing cost thereof.

The present disclosure provides an exhaust plug for an aircraft turbojet engine including a front part designed to be attached to a rear part each having an outer skin, characterized in that the front part and the rear part are connected by at least one connecting flange shared by those two parts and on which the outer skins are placed side by side.

The shared connecting flange, similar to a stiffener, may be made in one or several peripheral sectors.

Owing to these features, a single flange is sufficient to connect the front and rear plug parts to each other, versus two separate flanges in the state of the art, which makes it possible to reduce the mass as well as manufacturing costs.

Furthermore, the fact that the outer skins of the front and rear parts are simply arranged side by side on the flange makes it possible to reduce the arranging problems of the prior art particularly related to the machining allowances of the flanges in particular.

According to other additional forms of the present disclosure:
the outer skin of said front part is attached on said flange by brazing;
the outer skin of said rear part is fastened on said flange using bolts and nuts: this fastening solution allows very simple assembly/disassembly of the rear part relative to the front part;
no housing for the heads of said bolts is provided in the outer skin of the rear plug or in the flange: in this way, the heads of the bolts protrude toward the outside of the exhaust plug; a slight aerodynamic deterioration caused by such a protrusion is allowed, to the benefit of simpler production of the parts (no stamping necessary to manufacture the housings), easier assembly (the heads of the bolts are more easily accessible), and mass savings (it is not necessary to provide overthicknesses in the parts, if no housings are provided);
said flange includes at least one reinforcing flanged edge;
said flange is formed by folded or stamped sheet metal; and
said outer skins are made from a metal alloy such as Inconel 625. Of course, other suitable materials may be chosen.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagrammatic perspective and axial cross-sectional view of an exhaust plug of the prior art, mentioned in the preamble of the present description,

FIG. 2 is a detailed view of zone II in FIG. 1; and

FIG. 3 is a view similar to that of FIG. 2, of an exhaust plug according to the present disclosure.

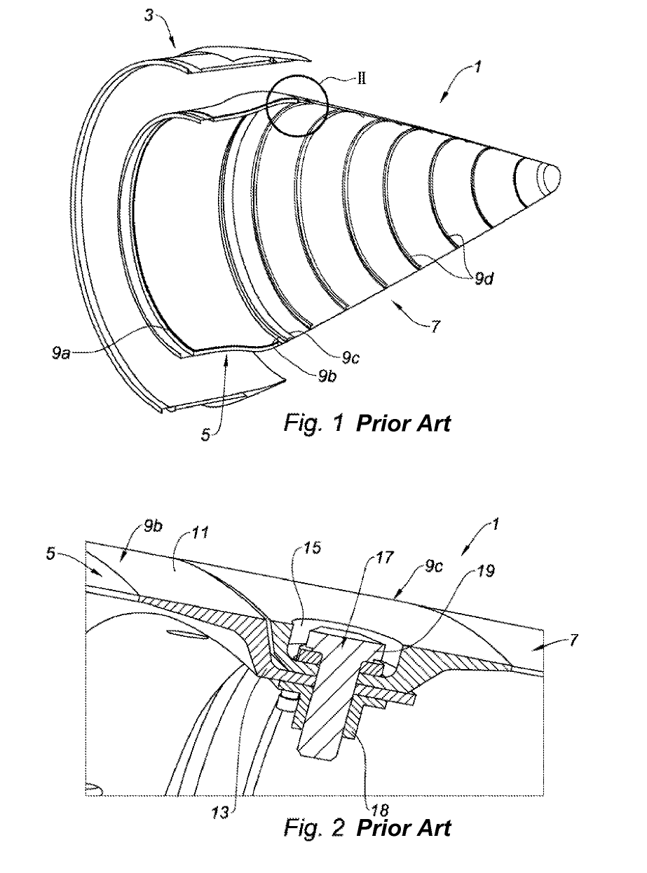

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

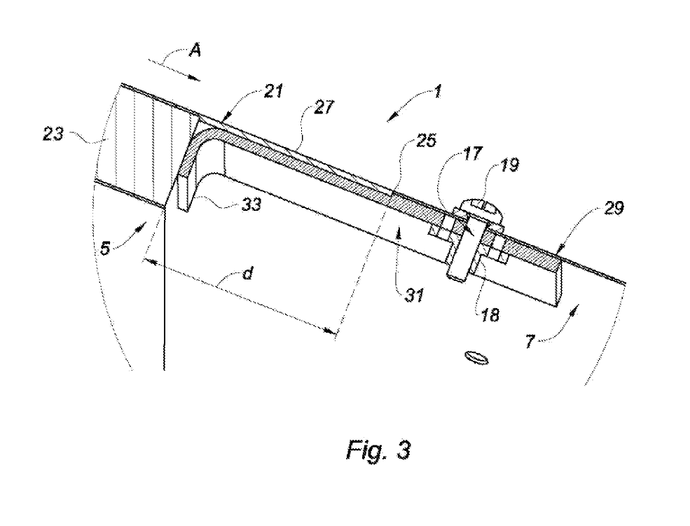

FIG. 3 shows that at its end, the front part 5 of the exhaust plug according to the present disclosure has a solid (not perforated) part 27 of outer skin 21. This outer skin 21 part 27 constitutes an extension of the normally perforated outer skin 21 making up the sound attenuation structure with the honeycomb 23 and the inner solid skin 5, performing sound treatment for the exhaust plug.

One can see that the acoustic structure 23 is interrupted at a certain distance d from the downstream edge 25 of the outer skin 21, and more specifically its solid part 27, thereby leaving the inner face of said solid part 27 free.

The outer skin 29 of the rear part 7 is positioned edge to edge with the downstream edge 25 of the outer skin 21 of the front plug part 5.

A metal flange 31, substantially in the shape of a cone segment of revolution, provides the connection between the outer skins 21 and 29 of the front 5 and rear 7 parts of the exhaust plug.

In one form, as shown in FIG. 3, the flange 31 may include a flanged edge 33, for example on its upstream part, so as to increase the stiffness thereof.

The flange 31 may be obtained using a folded or stamped sheet.

It should be noted that this flange may be formed in a single piece over the entire periphery of the exhaust plug, or in several sectors positioned in the extension of one another.

The metal alloy from which the outer skins 21 and 29 as well as the flange 31 are made may be Inconel 625, commonly used in the aeronautic industry, but is not, of course, limited thereto.

The outer skin 21 of the front part 5 may be fastened on the flange 31 by brazing or welding.

The outer skin 29 of the rear part 7 may be fastened on the flange 31 such that it can be disassembled, preferably using bolts 17 passing through the orifices formed in said outer skin 29 and said flange 31, nuts 18 being positioned on the concave side of the flange 31 so as to retain said bolts 17.

Unlike the state of the art shown in particular in FIG. 2, the heads 19 of the bolts 17 are allowed to protrude from the surface defined by the outer skin 29.

It is in fact considered that the aerodynamic losses created by these heads 19 are acceptable in light of the other advantages procured by this arrangement, i.e., inter alia: no need to produce housings for the heads 19 in the outer skin 29 and the flange 31, which allows simpler manufacturing of the parts (no stamping necessary to manufacture the housings), easier assembly (heads 19 of the bolts 17 are more easily accessible), and mass reduction (it is not necessary to provide overthicknesses in the outer skin 29 and the flange 31 if no housings are provided).

It will be noted that with this particular arrangement, it is easy to assemble and disassemble the rear part 7 relative to the front part 5.

The arrangement problems are furthermore reduced related to the respective allowances of the flanges 9b and 9c of the front 5 and rear 7 parts of the exhaust plug of the prior art.

FIG. 3 shows a single bolt 17, but it must of course be understood that several of said bolts are distributed at regular or irregular intervals over the entire periphery of the outer skin 29 of the rear plug part 7.

Of course, the present disclosure is in no way limited to the forms described and shown.

What is claimed is:

1. An exhaust plug for an aircraft turbojet engine, said exhaust plug comprising:
a front part being attached to a rear part, said front and rear parts each having an outer skin,
wherein the front part and the rear part are connected by at least one connecting flange shared by the front and rear parts and on which the outer skins of the front and rear parts are placed side by side.

2. The exhaust plug according to claim 1, wherein the outer skin of said front part is attached on said at least one connecting flange by brazing.

3. The exhaust plug according to claim 1, wherein the outer skin of said rear part is fastened on said at least one connecting flange using bolts and nuts.

4. The exhaust plug according to claim 3, wherein no housing for heads of said bolts is provided in the outer skin of the rear plug or in the at least one connecting flange.

5. The exhaust plug according to claim 1, wherein said at least one connecting flange includes at least one reinforcing flanged edge.

6. The exhaust plug according to claim 1, wherein said at least one connecting flange is formed by folded or stamped sheet metal.

7. The exhaust plug according to claim 1, wherein said outer skin of the front and rear parts is made from a metal alloy.

8. The exhaust plug according to claim 1, wherein said outer skin of the front and rear parts is made from a Nickel-Chromium alloy.
